(19) United States
(12) Patent Application Publication
(10) Pub. No.: US 2026/0090654 A1
(43) Pub. Date: Apr. 2, 2026

(54) BREATHABLE CRIB FOR CHEST-SLEEPING

(71) Applicant: Lee Redden, Palo Alto, CA (US)

(72) Inventor: Lee Redden, Palo Alto, CA (US)

(21) Appl. No.: 19/343,553

(22) Filed: Sep. 29, 2025

Related U.S. Application Data
(60) Provisional application No. 63/700,454, filed on Sep. 27, 2024.

(51) Int. Cl. A47D 9/00; G06T 7/70; G06V 40/10; G08B 21/02; G08B 21/18

(52) U.S. Cl. CPC A47D 9/012; G06T 7/70; G06V 40/15; G08B 21/0211; G08B 21/182; G06T 2207/30196

(57) ABSTRACT

A system includes: a frame comprising a set of upper frame elements circumscribing a rectangular section and a set of lower frame elements; a sling comprising a unitary structure of continuous mesh material characterized by at least 50% open area and a sleeping area defining head, torso, and xlsx leg regions; a tension connectors arranged radially about the sleeping section; a set of wall sections extending upwardly from the sleeping area and including left and right sidewalls and upper and lower endwalls; a set of upper frame attachments that couple distal ends of the wall sections to the upper frame elements; a set of tensioners configured to couple the tension connectors to the bottom frame elements to tension the sleeping area into a plane.

### CROSS-REFERENCE TO RELATED APPLICATIONS

This Application claims priority to U.S. Provisional Patent Application No. 63/700,454, filed on 27 Sep. 2024, which is incorporated in its entirety by this reference.

### TECHNICAL FIELD

This invention relates generally to the field of infant cribs and more specifically to a new and useful breathable infant crib for ergonomic chest-sleeping and back-sleeping and continuous infant monitoring.

### BRIEF DESCRIPTION OF THE FIGURES

FIG. 1 is a schematic representation of a system;

FIG. 2A is a schematic representation of one variation of the system;

FIG. 2B is a schematic representation of one variation of the system; and

FIG. 2C is a schematic representation of one variation of the system.

### DESCRIPTION OF THE EMBODIMENTS

The following description of embodiments of the invention is not intended to limit the invention to these embodiments but rather to enable a person skilled in the art to make and use this invention. Variations, configurations, implementations, example implementations, and examples described herein are optional and are not exclusive to the variations, configurations, implementations, example implementations, and examples they describe. The invention described herein can include any and all permutations of these variations, configurations, implementations, example implementations, and examples.

### 1. System

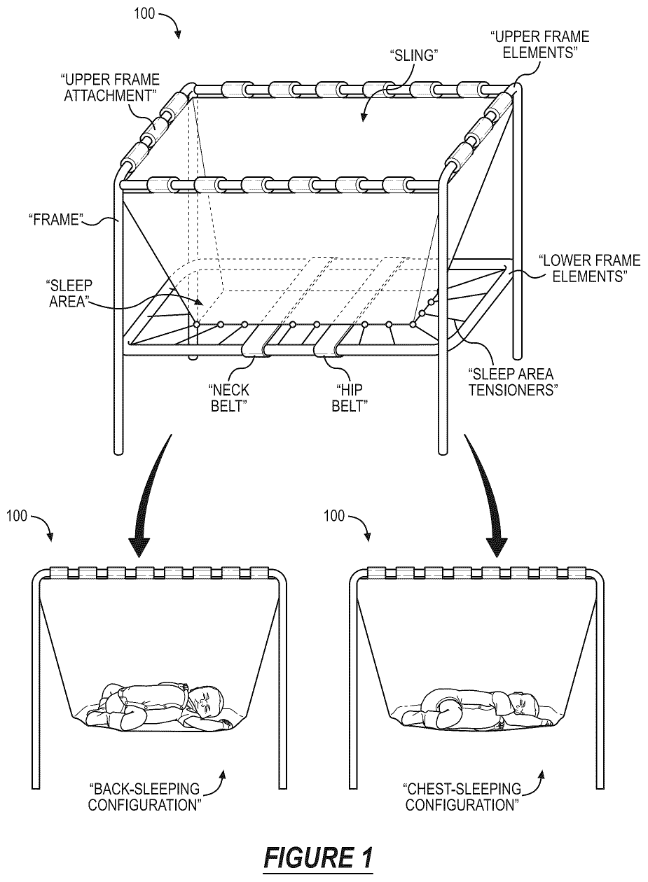

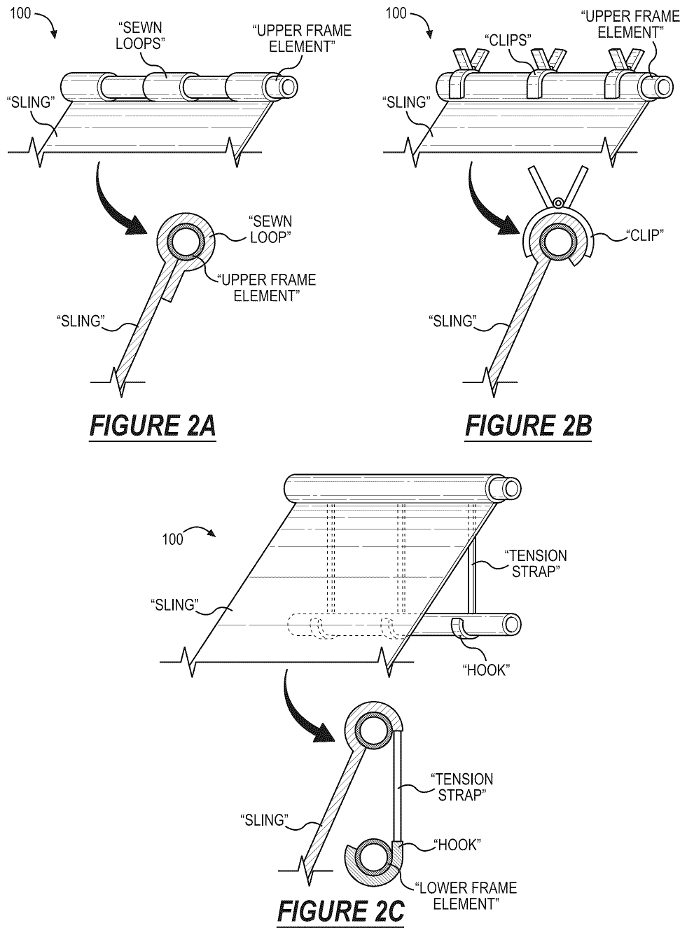

As shown in FIG. 1, a system 100 includes a frame including: a set of upper frame elements circumscribing a rectangular section; and a set of lower frame elements arranged below the set of upper frame elements. The system 100 also includes a sling including a unitary structure of continuous mesh material characterized by at least 50% open area. The sling includes a sleeping area defining: a head region; a torso region; and a leg region. The system 100 also includes a set of sleeping area tension connectors arranged radially about the sleeping section. The sling also includes a set of wall sections extending upwardly from the sleeping area and including: a left sidewall; a right sidewall; an upper endwall; and a lower endwall.

The system 100 also includes a set of upper frame attachments configured to couple distal ends of the set of wall sections to the set of upper frame elements of the frame. The system 100 also includes a set of sleeping section tensioners configured to: couple the sleeping area tension connectors to the set of bottom frame elements; and tension the sleeping area into a plane.

The system 100 also includes a chest belt: extending between the set of lower frame elements; extending laterally across the sleeping area; and partitioning the head region from the torso region of the sleeping area of the sling. Operable in back-sleeping configuration, the chest belt applies a first tension across the set of lower frame elements. Operable in chest-sleeping configuration, the chest belt applies a second tension, greater than the first tension, across the set of lower frame elements.

The system 100 also includes a hip belt: extending between the lower frame elements; extending laterally across the sleeping area; and partitioning the torso region from the leg region of the sleeping area of the sling. Operable in the back-sleeping configuration, the hip belt applies a third tension across the set of lower frame elements. Operable in the chest-sleeping configuration, the hip belt applies a fourth tension, greater than the third tension, across the set of lower frame elements.

The system 100 also includes a set of belt tensioners configured to transition the chest belt and the hip belt between the back-sleeping configuration and the chest-sleeping configuration.

### 1.1 Variation: System for Infant Sleep Position Monitoring

In one variation: the system 100 includes a first camera: arranged below the sleeping area; defining a first field of view spanning the sleeping area; and configured to capture a first set of images of an infant lying in a chest-sleeping position in the sleeping area. The system 100 also includes a second camera: arranged above the sleeping area; defining a second field of view spanning the sleeping area; and configured to capture a second set of images of the infant lying in a back-sleeping position in the sleeping area. The system 100 also includes a controller configured to: access the first set of images and the second set of images captured during a first time period; based on the first set of images and the second set of images, detect a change in the sleep position of the infant from a back-sleeping position to a chest-sleeping position; and generate a notification prompting the user to adjust the set of sleep area tensioners from the back-sleeping configuration to the chest-sleeping configuration.

### 1.2 Variation: System for Infant Pulse-Oximetry Monitoring

In one variation: the system 100 includes a first camera: arranged below the sleeping area; defining a first field of view spanning the sleeping area; and configured to capture a first set of images of an infant lying in a chest-sleeping position in the sleeping area. The system 100 also includes a second camera: arranged above the sleeping area; defining a second field of view spanning the sleeping area; and configured to capture a second set of images of the infant lying in a back-sleeping position in the sleeping area. The system 100 also includes a controller configured to: access the first set of images and the second set of images; based on the first set of images and the second set of images, detect a blood oxygen level in the face of the infant; and, in response to the blood oxygen level falling below a threshold, generate an alarm prompting the infant to wake and change the sleeping position and/or indicating to the user an increased risk of suffocation of the infant.

### 2. Applications

Generally, the system 100 for infant containment and monitoring includes a perforated (or “mesh”) sling, a frame supporting the sling, and a set of belts configured to apply a range of lateral tensions across the frame to support an infant in both chest and back sleep positions. The sling is perforated to pass infant regurgitation (i.e., pediatric emesis) downwardly and away from the face of the infant regardless of the infant's sleeping position in order to reduce risk of aspiration of emesis in the infant.

In particular, the sling: can be a unitary (i.e., one-piece) mesh structure with at least 50% open area; can define a sleeping area configured to support the infant lying on her chest or her back; and can define wall sections extending upwardly from the sleeping area toward an upper frame element of the frame and surrounding the infant. The frame: includes the upper frame element and a bottom frame element circumscribing a rectangular section (e.g., circumscribing a cuboid volume); and is configured to support the sling. For example, the frame can include: twelve straight sections, such as polyvinyl chloride, nylon, or fiberglass tubes or wooden rods; and eight connectors, such as three-way and four-way corner connectors. The system 100 also includes: a set of upper frame attachments configured to couple the wall sections to the upper frame elements of the frame; and a set of sleeping section tensioners configured to tension the sleeping area into a flat surface that supports the infant placed into the system 100.

Accordingly, system 100 defines the sleeping area: formed of a permeable mesh material and configured to support the infant; and pervious to air and fluids (e.g., emesis). In particular, because the sling defines a high open ratio of perforations, the system 100 can both: enable air to circulate around the infant; and enable fluid to drain downwardly and away from the infant's face. The system 100 can therefore reduce risk of infant aspiration of emesis and suffocation, such as caused by a lack of air flow near the infant's face or caused by pooling of bodily fluids proximal the infant's face when the infant occupies a chest-sleeping position.

### 2.1 Spinal Shape Control for Chest and Back Sleepers

The system 100 further includes a chest belt configured to extend laterally across the sleeping area and to support the upper chest or the upper back of the infant. In particular, the chest belt can: apply a first tension across the sleeping area when the infant sleeps on her back (i.e., when the system 100 occupies a “back-sleeping” configuration); and apply a second tension, exceeding the first tension, across the sleeping area when the infant sleeps on her chest (i.e., when the system 100 occupies a “chest-sleeping” configuration). Therefore, in the chest-sleeping configuration, the chest belt can prevent the infant's chest from sagging below the infant's head, thereby maintaining a proper curvature of the infant's spine when sleeping on her chest. Additionally, in the back-sleeping configuration, the chest belt can: allow a back, a neck, and the head of the infant to assume a neutral position, such as with the infant's back level with or below the infant's head, as in a hammock; and to maintain proper curvature of the infant's spine when sleeping on her back.

The system 100 similarly includes the hip belt configured to extend laterally across the sleeping area and to support the infant's hips. Specifically, the hip belt can: apply a third tension across the lower frame elements in the back-sleeping configuration; and apply a fourth tension, greater than the third tension, across the lower frame elements in the chest-sleeping configuration. Therefore, in the chest-sleeping configuration, the hip belt can prevent the infant's torso (or “belly”) from sagging below the infant's legs and thus cooperate with the chest belt to maintain proper curvature of the infant's spine. Additionally, in the back-sleeping configuration, the hip belt can: allow the back and the legs of the infant to assume a neutral position, such as with the back below the legs, as in a hammock; and thus, cooperate with the chest belt to maintain a proper curvature of the infant's spine.

The system 100 can also include a first belt tensioner configured to transition the chest belt between the first tension and the second tension and the second belt tensioner configured to transition the hip belt between the third tension and the fourth tension. For example, in response to seeing the infant in the chest-sleeping position, the user may: adjust the first belt tensioner to set the first tension of the chest belt; or adjust the second belt tensioner to set the third tension of the hip belt. Therefore, by transitioning between different tensions of the chest belt and the hip belt, the system 100 can transition between two configurations to adapt to the sleeping position of the infant and provide an ergonomic sleeping area tailored to each sleeping position.

### 2.2 Assembly

In one example, the system 100 is supplied to a user in a disassembled, compact format and is assembled into a portable, lightweight, and rigid crib that accommodates both chest- and back-sleeping infants.

For example, a user (e.g., a new parent) may assemble the system 100 from a kit by: assembling the frame, such as from twelve straight polyvinyl tubes and eight corner connectors; draping the sling over the frame; attaching the sling to the upper frame elements with the set of upper frame attachments; attaching the set of sleeping section tensioners to the lower frame elements to tension the sleeping area into a flat surface; and tensioning the hip belt and the chest belt across the lower frame elements. Therefore, the system 100 can be assembled by the user, from the compact and portable kit containing individual components of the system 100. Furthermore, the individual components of the system 100 can be formed of common materials, such as polyvinyl tubes and connectors, wood rods or dowels and nylon corner connectors, and/or mesh netting material formed of natural (e.g., cotton) or synthetic (e.g., nylon) fibers.

Accordingly, the system 100 may be more accessible to households with a wide range of household incomes and can reduce risk of aspiration of emesis across a larger number of infants.

### 2.3 Infant Tracking

In one variation, the system 100 further includes: at set of (e.g., two) cameras (e.g., RGB, thermal, or hyperspectral cameras) configured to face and to capture images of the infant's head; and a control configured to access images from the set of cameras, to monitor the infant's health status based on features detected in these images, and to selectively output alerts responsive to changes or degradation in the infant's health status.

In one implementation, the system 100 includes a pair of color cameras configured: to mount on each side of the sleeping area; to mount above and point downwardly toward the sleeping area; and to capture images of the infant's face when the system 100 is in the back-sleeping configuration. In this implementation, the pair of color cameras can also be configured: to mount on each side of the sleeping area; to mount below and point upwardly toward the sleeping area; and to capture images of the infant's face when the system 100 is in the chest-sleeping configuration. Thus, the user may selectively mount the cameras on the frame and adjust tension in the chest and hip belts based on whether the infant is placed or sleeping on her back or chest.

In this variation, the controller can: access images output by these cameras; implement photoplethysmography techniques to estimate blood oxygen level in the infant's face and/or other exposed body parts based on color signals detected in these images; and trigger an alarm indicating an increased risk of suffocation or aspiration in response to this blood oxygen level falling below a threshold blood oxygen level (such as for more than a threshold time duration). Therefore, the system 100 can enable blood oximetry monitoring of the infant via a set of cameras that can be selectively positioned on upper or lower rails of the frame based on how the infant sleeps or is placed in the system 100.

In particular, due to large perforations in the sling and a large open ratio of the sling, the cameras can capture images that contain sufficient color information of an infant's face—when the infant is sleeping on her chest and the cameras are facing upwardly at the sling—to enable the controller to derive an accurate photoplethysmographic-based blood oximetry value for the infant from images captured by the cameras, such as without necessitating a different material or sling geometry near the infant's face. Thus, the system 100 can both: reduce risk of infant suffocation or aspiration, especially for an infant lying in the chest-sleeping position; and track infant health in both chest- and back-sleeping positions, thereby enabling a user to leave the infant unsupervised in the sleeping area.

Furthermore, in this variation, based on a set of images captured by the set of cameras during a period of time, the controller can: detect a change in the sleep position (e.g., from the chest-sleeping position to back-sleeping position) of the infant; and generate a notification informing the user of the change in the sleep position. For example, the controller can: detect the infant shift from the chest-sleeping position to the back-sleeping position, such as based on presence and then absence of the infant's face against the sling in images captured by the cameras on the upwardly-facing orientation on lower rails of the frame; and then generate a notification prompting the user to transition the chest belt from the first tension to the second tension and transition the hip belt from the third tension to the fourth tension. Therefore, the system 100 can leverage data captured by the cameras to: monitor the sleeping position of the infant; and prompt the user to manually adjust the chest belt and the hip belt to target tensions corresponding to the sleeping position of the infant, thereby maintaining an ergonomic sleeping surface for the infant.

### 2.4 Other Configurations

Although the upper frame elements and the lower frame elements are described herein as “circumscribing a rectangular section,” the upper frame elements and the lower frame elements can circumscribe a variety of other geometries, such as circle, oval, parallelogram, or irregular shape. Furthermore, the sling can include a variety of breathable meshes and fabrics with a range of open area percentages (e.g., between 20% and 80%) that can support the weight of the infant without exerting excessive pressure on any one area of the body of the infant and remaining readily permeable to fluids and air.

### 3. Frame

The system 100 includes the frame including: the set of upper frame elements circumscribing a rectangular section; and the set of lower frame elements circumscribing a rectangular section and arranged at a fixed distance below the set of upper frame elements. The frame also includes a set of columns: arranged perpendicular to the set of upper frame elements and the set of lower frame elements; joined to the set of upper frame elements and the set of lower frame elements; and supporting the set of lower frame elements a second fixed distance from the support surface upholding the frame, such as the floor.

In one example, the frame includes: a set of twelve straight sections, such as segments of a polyvinyl tube; a set of four three-way connectors, such as three-way side outlet elbows; and a set of four four-way connectors, such as a four-way side outlet tees. More specifically, the upper frame element can include the set of four three-way connectors connecting four straight sections and the lower frame element can include the set of four four-way connectors connecting eight straight sections.

### 4. Sling

The system 100 includes the sling including: a unitary structure of continuous mesh material characterized by an open area within a first range of percentages (e.g., 40%-80%). The sling can include the sleeping area: configured to support the infant in the horizontal lying position; and defining the head region, the torso region, and the leg region. For example, the user may place the infant on the sleeping area such that that the head of the infant is in the head region, the torso of the infant is in the torso region, and the legs of the infant are in the leg region. Additionally, the sling can include the set of wall sections extending upwardly from the sleeping area and including the left sidewall, the right sidewall, the upper endwall, and the lower endwall.

In one implementation, the mesh material can include a uniaxially stretchable mesh designed to expand along a single stretch axis. For example, the user may place the infant in the sling such that the stretch axis of the mesh is perpendicular to the longitudinal axis (e.g., spine) of the infant. Thus, the sling, fitted over the frame, can remain tensioned (i.e., rigid) along the longitudinal axis of the infant providing a firm sleep surface that prevents excess arching of the spine of the infant (due to longitudinal rigidity). Simultaneously, the sling can stretch along the frontal axis of the infant ensuring that the sleep area is soft and comfortable.

### 5. Upper Frame Attachments

The system 100 can include the set of upper frame attachments configured to couple distal ends of the set of wall sections to the set of upper frame elements of the frame.

In one implementation, the set of upper frame attachments can include: sewn loops arranged on distal ends of the wall sections; and configured to wrap around the set of upper frame attachments. For example, to assemble the system 100, the user may insert the straight sections of the set of upper frame attachments into the sewn loops of the wall sections and then secure the straight sections with the three-way connectors.

In one implementation, the set of upper frame attachments can include a set of clips that clip over the distal ends of the wall sections and around the set of upper frame elements. For example, to assemble the system 100, the user may fold the sling over the set of upper frame elements and then add clips to retain the set of wall sections of the sling folded over the set of upper frame elements. Accordingly, the set of upper frame attachments can equally distribute tension from the sling across the rectangular section circumscribed by the upper frame element, thereby ensuring stability of the frame.

In one implementation, the set of upper frame attachments can include a set of sewn tension straps: arranged radially on the distal ends of the wall sections; and configured to connect to the set of lower frame elements. More specifically, the tension straps can include hooks arranged on the distal ends of the tension straps, the hooks configured to hook onto the set of lower frame elements. For example, to assemble the system 100, the user may: fold the sling over the frame; pull the distal ends of each of the tension straps toward the lower frame elements; and connect (e.g., hook) the distal ends of each of the tension straps to the lower frame elements.

### 6. Sleeping Area Tension Connectors

The system 100 can include a set of sleeping area tension connectors arranged radially about the sleeping area and configured to connect to the set of sleeping area tensioners. For example, the set of sleeping area tension connectors can include sewn loops, hooks, buttons, or snaps arranged radially about the sleeping area and configured to connect to hooks, loops, buttons, or snaps on the proximal ends of the set of sleeping area tensioners.

### 7. Sleeping Area Tensioners

The system 100 can include the set of sleeping section tensioners configured to: couple the sleeping area tension connectors to the set of lower frame elements and tension the sleeping area into a plane. The set of sleeping area tensioners can equally distribute tension from the sling to the bottom frame elements, thereby ensuring stability of the frame.

In one implementation, the set of set of sleeping section tensioners can include a second set of tension straps: arranged radially on the sling about the sleeping section; and configured to connect to the lower frame elements or the sleeping area tension connectors. For example, the second set of tension straps can be sewn on to the sling around the perimeter of the sleeping area and include hooks or clips arranged on the distal ends of the tension straps, the hooks or clips configured to hook onto the set of lower frame elements. To assemble the system 100, the user may fold the sling over the frame, connect the set of upper frame attachments to the set of upper frame elements, and then connect the second set of tension straps to the set of lower frame elements.

### 8. Chest Belt

The system 100 includes the chest belt: extending between the lower frame elements; extending laterally across the sleeping area; and partitioning the head region from the torso region of the sleeping area. For example, the hip belt can include a piece of fabric defining a length approximating the width of the sleeping area and defining a surface area sufficient to support the weight of the upper body of the infant without exerting excessive pressure on the upper chest or the upper back of the infant (to prevent bruising, suffocation).

Operable in the back-sleeping configuration, the chest belt is configured to apply the first tension across the lower frame elements. Operable in the chest-sleeping configuration, the chest belt is configured to apply the second tension, greater than the first tension, across the lower frame elements.

In one example, in the chest-sleeping configuration, the chest belt is configured to support the upper chest of the infant in the chest-sleeping position, such that the chest of the infant is level or elevated relative to the infant's head. Therefore, in the chest-sleeping configuration, the chest belt is configured to: prevent the chest of the infant from sagging below the head; prevent excessive improper inward bending of the spine of the infant due to stretching of the mesh material in the longitudinal direction; and provide an ergonomic sleeping surface tailored to the chest-sleeping position of the infant.

In another example, in the back-sleeping configuration, the chest belt is configured to support the upper back of the infant, such that the upper back is either level with the head or below the head of the infant. Therefore, in the back-sleeping configuration, the chest belt is configured to: allow the back, the neck, and the head of the infant to assume a neutral position, such as when the back is level or below the head (as in a hammock); and provide an ergonomic sleeping surface tailored to the back-sleeping position of the infant.

### 9. Hip Belt

The system 100 includes the hip belt: extending between the lower frame elements; extending laterally across the sleeping area; and partitioning the torso region from the leg region of the sleeping area. For example, the hip belt can include a second piece of fabric defining the length approximating the width of the sleeping area and defining a second surface area sufficient to support the weight of the lower body of the infant without exerting excessive pressure on any one part of the body of the infant (to prevent bruising, suffocation).

Operable in the back-sleeping configuration, the hip belt is configured to apply a third tension across the lower frame elements. Operable in the chest-sleeping configuration, the hip belt is configured to apply a fourth tension, greater than the third tension, across the lower frame elements.

In one example, when the system 100 is in the chest-sleeping configuration, the hip belt is configured to support the hips of the infant sleeping in the chest-sleeping position, such that the hips of the infant are level or elevated relative to the knees and feet of the infant. Therefore, in the chest-sleeping configuration, the hip belt is configured to: prevent the hips of the infant from sagging below the legs; prevent improper inward bending of the back of the infant due to stretching of the mesh material in the longitudinal direction (i.e., parallel to the infant's spine); and provide an ergonomic sleeping surface tailored to the chest-sleeping position of the infant.

In another example, when the system 100 is in the back-sleeping configuration, the hip belt is configured to support the lower back of the infant in the back-sleeping position, such that the lower back is either level or recessed relative to the knees and feet of the infant. Therefore, in the back-sleeping configuration, the chest belt is configured to: allow the lower back and the legs of the infant to be in a neutral position, as in a hammock; and provide ergonomic sleeping surface tailored to the back-sleeping position of the infant.

### 10. Belt Tensioners

The system 100 includes a set of belt tensioners configured to: transition the chest belt and the hip belt between the back-sleeping configuration and the chest-sleeping configuration. More specifically, the set of belt tensioners can include: a first belt tensioner configured to transition the chest belt between the first tension and the second tension; and a second belt tensioner configured to transition the hip belt between the third tension and the fourth tension. For example, the user may adjust the set of belt tensioners to transition the chest belt and the hip belt from the back-sleeping configuration to the chest-sleeping configuration in response to the infant turning from the back-sleeping position to the chest-sleeping position. Therefore, the system 100 includes the set of belt tensioners, which enable the user to manually adjust the tensions of the chest belt and the hip belt in response to changing sleep position of the infant.

In one implementation, the set of belt tensioners includes a bistable cable tensioner that includes: a lever (pivoting arm) that pivots between a first position corresponding to the chest-sleeping configuration and a second position corresponding to the back-sleeping configuration; and a cam or a ratchet mechanism linked to the pivoting arm. In the first position of the pivoting arm, the cam or the ratchet mechanism is configured to reduce an effective length of the hip belt or the chest belt, thereby increasing the tension in the chest belt or the hip belt. In the second position of the pivoting arm, the cam or the ratchet mechanism is configured to increase the effective length of the hip belt or the chest belt, thereby reducing the tension in the chest belt or the hip belt. In this implementation, to adjust the belt tension, the user may turn the pivoting arm from the first position to the second position in response to the infant transitioning from the chest-sleeping position to the back-sleeping position.

In one implementation, a belt tensioner in the set of belt tensioners includes two bungees configured to be connected to the hip belt or the chest belt. More specifically, the belt tensioner includes a first bungee: including a first loop at the untethered end; defining a first length; and corresponding to the chest-sleeping configuration. Additionally, the belt tensioner includes: a second bungee including a second loop at the untethered end; defining a second length, greater than the first length; and corresponding to the back-sleeping configuration. Furthermore, the belt tensioner can include a pin: arranged on one of the set of upper frame elements or one of the set of lower frame elements; and configured to retain the first loop or the second loop. For example, to adjust the tension on the hip belt or the chest belt, the user may unhook a first loop of the first bungee from the pin and hook a second loop of the second bungee to the pin.

Therefore, the system 100 includes the set of belt tensioners, which enable the user to manually transition the tensions of the chest belt and the hip belt between two pre-set tension settings: one tailored to the back-sleeping position; and another tailored to the chest-sleeping position of the infant.

In one implementation, the belt tensioner in the set of belt tensioners includes a Velcro strap. For example, the hip belt or the chest belt can include a “hook” segment that includes a set of hooks and an outer surface of the left or the right sidewall of the sling can include a “loop” area that includes a set of loops. Furthermore, the loop area can further include two position indications: a first position indication corresponding to the chest-sleeping configuration; and a second position indication corresponding to the back-sleeping configuration. Accordingly, in response to seeing that the infant has turned from the back-sleeping position to the chest-sleeping position, the user may: detach the hook segment of the hip belt or the chest belt from the loop area; align the hook segment with the first position inaction; and attach the hook segment to the loop area at the first position indication.

In one implementation, the belt tensioner in the set of belt tensioners includes a “tuning peg” configured to adjust the tension of the hip belt or the chest belt. More specifically, the belt tensioner can include: a spool arranged on one of the set of lower frame elements and attached to the hip belt or the chest belt; and a set of gears configured to lock the spool at a rotational position corresponding to a target tension of the hip belt or the chest belt. In this implementation, the user may adjust the tension of the hip belt or the chest belt by turning the spool.

Therefore, the system 100 includes the set of belt tensioners, which enable the user to manually transition the tensions of the chest belt and the hip belt between a range of tensions. Thus, the user may manually identify target tensions of the chest belt and the hip belt that are linked with the highest sleep quality or longest sleep durations of the infant.

In one implementation, the belt tensioner in the set of belt tensioners includes an actuator or a motor: communicatively coupled to the controller; configured to access a signal from the controller; and, in response to accessing the signal, transition the belt tensioner between the chest-sleeping configuration and the back-sleeping configuration. For example, in response to accessing the signal, the actuator or the motor can pivot the lever (pivoting arm) from the first position corresponding to the chest-sleeping configuration and the second position corresponding to the back-sleeping configuration. Therefore, the belt tensioner can automatically transition the neck belt or the hip belt to the sleeping configuration corresponding to a current sleeping position of the infant, as detected by the controller.

### 11. Optical Sensors and Light Sources

The system 100 can include one or more optical sensors, such as hyperspectral cameras, red-green-blue (RGB) cameras, or infrared cameras: arranged above and/or below the sleeping area; defining a field of view spanning the sleeping area; and configured to capture images of the infant. Due to the permeability of the mesh material of the sling, an optical sensor in the set of optical sensors, arranged below the sleeping area, can capture images of the face of the infant in the chest-sleeping position.

In one implementation, the system 100 can include one or more optical sensors configured to transiently mount on the upper frame elements and the lower frame elements on each side of the sleeping area. More specifically, one or more optical sensors can be configured to: mount (e.g., clip) on the upper frame elements and point downwardly toward the sleeping area; and capture images of the infant's face when the system 100 is in the back-sleeping configuration. In this implementation, one or more optical sensors can also be configured to: mount on the lower frame elements and point upward toward the sleeping area; and capture images of the infant's face when the system 100 is in the chest-sleeping configuration. Thus, the user may selectively mount one or more optical sensors on the frame and adjust tension in the chest and hip belts based on whether the infant is placed or sleeping on her back or chest. For example, in response to the infant transitioning from the back-sleeping position to the chest-sleeping position, the user may dismount one or more optical sensors from the upper frame elements and mount one or more optical sensors on the lower frame elements pointing upward.

In one implementation, the system 100 can include one or more infrared light sources: arranged above or below the sleeping area; defining an illumination field spanning the sleeping area; and configured to cast infrared light onto the infant in dark conditions, such as at night. The infrared light source can enable the optical sensor to capture images of the infant in dark conditions without illuminating the infant with a conventional (e.g., visible to the human eye) light source, which may wake the infant.

### 12. Controller

The system 100 can include the controller configured to: access images captured by the set of optical sensors; implement photoplethysmography techniques to estimate a blood oxygen level of the infant based on the images and, in response to the blood oxygen level falling below a threshold, generate an alarm to wake the infant and prompt the infant to change position and/or to notify the user of an increased suffocation risk. Accordingly, the controller can enable continuous monitoring of the blood oximetry of the infant in the sleeping area, even when the infant is in the chest-sleeping position. Therefore, the system 100 can enable the user to leave the infant in the sleeping area unattended without an increased risk of suffocation.

In one implementation, the system 100 can include the controller configured to: access images captured by the set of optical sensors; implement computer vision techniques to detect a change in the sleeping position of the infant based on the images; and generate a notification to adjust the tensions on the chest belt and the hip belt. For example, the controller can: implement computer vision techniques to detect the face of the infant in the images; and, in response to detecting the face of the infant in a first set of images captured at a first time and detecting an absence of the face of the infant in a second set of images captured at a second time succeeding the first time, detect a change from the back-sleeping position to the chest-sleeping position. In this implementation, based on a set of images captured during a time period, the controller can: detect a first frequency of the change in infant sleep position from the back-sleeping position to the chest-sleeping position; and detect a second frequency of the change in infant sleep position from the chest-sleeping position to the back-sleeping position. Then, in response to a difference between the first frequency and the second frequency exceeding a threshold frequency, the controller can identify the chest-sleeping position as the preferred sleeping position and generate a second notification instructing the user to maintain the system 100 in the chest-sleeping configuration. Therefore, the system 100 can automatically identify the preferred sleeping position of the infant and enable the user to maintain the tensions of the hip belt and the chest belt tailored to the preferred sleeping position.

In one implementation, the controller, communicatively coupled to the actuator or the motor of the belt tensioner, can: based on images accessed from one or more optical sensors, detect a change in infant position from the back-sleeping position to the chest-sleeping position; and, in response to detecting the change in infant position, generate a signal configured to transition the belt tensioner from the back-sleeping configuration to the chest-sleeping configuration. Therefore, the system 100 can automatically adjust the tensions on the hip belt and the chest belt to provide an ergonomic sleeping area tailored to each sleep position.

The systems and methods described herein can be embodied and/or implemented at least in part as a machine configured to receive a computer-readable medium storing computer-readable instructions. The instructions can be executed by computer-executable components integrated with the application, applet, host, server, network, website, communication service, communication interface, hardware/firmware/software elements of a user computer or mobile device, wristband, smartphone, or any suitable combination thereof. Other systems and methods of the embodiment can be embodied and/or implemented at least in part as a machine configured to receive a computer-readable medium storing computer-readable instructions. The instructions can be executed by computer-executable components integrated by computer-executable components integrated with apparatuses and networks of the type described above. The computer-readable medium can be stored on any suitable computer readable media such as RAMs, ROMs, flash memory, EEPROMs, optical devices (CD or DVD), hard drives, floppy drives, or any suitable device. The computer-executable component can be a processor but any suitable dedicated hardware device can (alternatively or additionally) execute the instructions.

As a person skilled in the art will recognize from the previous detailed description and from the figures and claims, modifications and changes can be made to the embodiments of the invention without departing from the scope of this invention as defined in the following claims.

I claim:

1. A system comprising:
a frame comprising:
a set of upper frame elements circumscribing a rectangular section; and
a set of lower frame elements arranged below the set of upper frame elements;
a sling comprising:
a unitary structure of continuous mesh material characterized by at least 50% open area; and
a sleeping area defining:
a head region;
a torso region; and
a leg region;
a set of sleeping area tension connectors arranged radially about the sleeping section;
a set of wall sections:
extending upwardly from the sleeping area; and
comprising:
a left sidewall;
a right sidewall;
an upper endwall; and
a lower endwall;
a set of upper frame attachments configured to couple distal ends of the set of wall sections to the set of upper frame elements of the frame; and
a set of sleeping section tensioners configured to:
couple the sleeping area tension connectors to the set of bottom frame elements; and
tension the sleeping area into a plane;

2. The system of claim 1:
further comprising a chest belt:
extending between the set of lower frame elements;
extending laterally across the sleeping area; and
partitioning the head region from the torso region of the sleeping area of the sling;
wherein the system is:
operable in back-sleeping configuration, the chest belt applies a first tension across the set of lower frame elements; and
operable in chest-sleeping configuration, the chest belt applies a second tension, greater than the first tension, across the set of lower frame elements.

3. The system of claim 1, further comprising:
a hip belt:
extending between the lower frame elements;
extending laterally across the sleeping area; and
partitioning the torso region from the leg region of the sleeping area of the sling; and
wherein the system is
operable in the back-sleeping configuration, the hip belt applies a third tension across the set of lower frame elements; and
operable in the chest-sleeping configuration, the hip belt applies a fourth tension, greater than the third tension, across the set of lower frame elements; and
further comprising a set of belt tensioners configured to transition the chest belt and the hip belt between the back-sleeping configuration and the chest-sleeping configuration.

4. The system of claim 1, further comprising:
further comprising a first camera:
arranged below the sleeping area;
defining a first field of view spanning the sleeping area; and
configured to capture a first set of images of an infant lying in a chest-sleeping position in the sleeping area;
a second camera:
arranged above the sleeping area;
defining a second field of view spanning the sleeping area; and
configured to capture a second set of images of the infant lying in a back-sleeping position in the sleeping area; and
a controller configured to:
access the first set of images and the second set of images captured during a first time period;
based on the first set of images and the second set of images, detect a change in the sleep position of the infant from a back-sleeping position to a chest-sleeping position; and
generate a notification prompting the user to adjust the set of sleep area tensioners from the back-sleeping configuration to the chest-sleeping configuration.

5. The system of claim 1, further comprising:
a first camera:
arranged below the sleeping area;
defining a first field of view spanning the sleeping area; and
configured to capture a first set of images of an infant lying in a chest-sleeping position in the sleeping area;
a second camera:
arranged above the sleeping area;
defining a second field of view spanning the sleeping area; and
configured to capture a second set of images of the infant lying in a back-sleeping position in the sleeping area; and
a controller configured to:
access the first set of images and the second set of images;
based on the first set of images and the second set of images, detect a blood oxygen level in the face of the infant; and
in response to the blood oxygen level falling below a threshold, generate an alarm prompting the infant to wake and change the sleeping position and/or indicating to the user an increased risk of suffocation of the infant;
